(19) United States
(12) Patent Application Publication
(10) Pub. No.: US 2006/0230335 A1
(43) Pub. Date: Oct. 12, 2006

(54) Linking user interface frames

(76) Inventor: Ilja Fischer, Heidelberg (DE)

Correspondence Address: FISH & RICHARDSON, P.C., PO BOX 1022, MINNEAPOLIS, MN, 55440-1022, US

(21) Appl. No.: 11/102,121

(22) Filed: Apr. 8, 2005

(51) Int. Cl. G06F 17/00

(52) U.S. Cl. 715/501.1; 715/513; 715/505; 715/512; 717/115; 717/162

(57) ABSTRACT

A method of generically linking a first user interface frame with a second user interface frame includes receiving developer input that selects the first user interface frame and the second user interface frame to be linked with one another. Additional developer input is received that specifies a first user interface page within which to display the first user interface frame and a second user interface page within which to display the second user interface frame. A generic linking function is associated with the first and second user interface frames. The generic linking function causes a first linking function to be executed if the first user interface page and the second user interface page are separate user interface pages. The generic linking function causes a second linking function to be executed if the first user interface page and the second user interface page are a common user interface page.

### TECHNICAL FIELD

This description relates to linking user interface frames.

### BACKGROUND

The increasing number and reach of local area and wide area networks has facilitated efficient retrieval and presentation of vast amounts data. A computer user may retrieve information through a hyperlink-based user interface page, as is common in Web pages. A Web portal may allow a computer user to effectively aggregate and manage information from a variety of sources. Frames within a portal page, or a set of portal pages, may further organize and link different kinds of information. For example, one portal page may include two linked frames. When the computer user selects information in one frame, linked information may be updated in the second frame. As another example, frames on different portal pages may also be linked. When the computer user selects information in one frame on a first portal page, a second portal page that includes a second frame may be loaded.

User interface pages and linked user interface frames may provide for efficient information management by computer users. To implement the linking described above, one version of programming code may be required to link two frames that are displayed on the same user interface page. A second version of programming code may be required to link to frames that are displayed on separate user interface pages. Changes to the arrangement of frames within a set of portal pages may necessitate changes to the programming code. If the programming code cannot be changed, the arrangement of the user interface frames on user interface pages may be inflexible.

### SUMMARY

A generic linking function may increase the flexibility of an environment of user interface pages and user interface frames. Moreover, a generic linking function may reduce or eliminate the need to change programming code when the arrangement of user interface frames is changed.

In a first general aspect, a method of generically linking a first user interface frame with a second user interface frame includes receiving developer input that selects the first user interface frame and the second user interface frame to be linked with one another. Additional developer input is received that specifies a first user interface page within which to display the first user interface frame and a second user interface page within which to display the second user interface frame. A generic linking function is associated with the first user interface frame and the second user interface frame. The generic linking function causes a first linking function to be executed, at run time, if the first user interface page and the second user interface page are separate user interface pages. The generic linking function causes a second linking function to be executed, at run time, if the first user interface page and the second user interface page are a common user interface page.

In a second general aspect, a method of navigating from a first user interface frame to a second user interface frame includes receiving, in a first user interface page, user input that is associated with the first user interface frame, the user input being to navigate to the second user interface frame. Context information associated with the second user interface frame is retrieved. The context information specifies whether the second user interface frame is to be displayed within the first user interface page or within a second user interface page. A generic linking function causes the first linking function to be executed if the context information specifies that the second user interface frame is to be displayed within the second user interface page. The generic linking function causes the second linking function to be executed if the context information specifies that the second user interface frame is to be displayed within the first user interface page.

The general and specific aspects may be implemented using a system, a method, or a computer program, or any combination of systems, methods, and computer programs. The details of one or more implementations are set forth in the accompanying drawings and the description below. Other features, objects, and advantages will be apparent from the description and drawings, and from the claims.

### DESCRIPTION OF DRAWINGS

FIG. 1A shows an exemplary pair of separate user interface pages that display linked user interface frames.

FIG. 1B shows an exemplary common user interface page that displays linked user interface frames.

FIG. 2A is a block diagram showing exemplary programming code and context information to link user interface frames on separate user interface pages.

FIG. 2B is a block diagram showing exemplary programming code and context information to link user interface frames on a common user interface page.

FIG. 3 is a flowchart of a method of generically linking a first user interface frame with a second user interface frame.

FIG. 4 is a flowchart of a method of navigating from a first user interface frame to a second user interface frame.

FIG. 5 is a block diagram of an exemplary computer system.

Like reference symbols in the various drawings indicate like elements.

### DETAILED DESCRIPTION

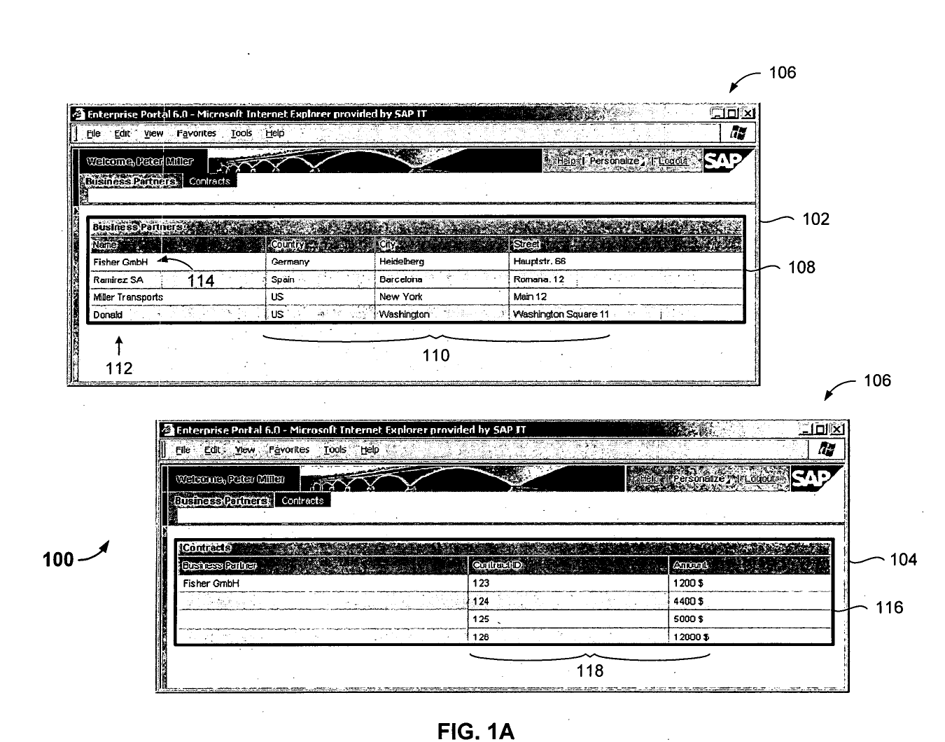

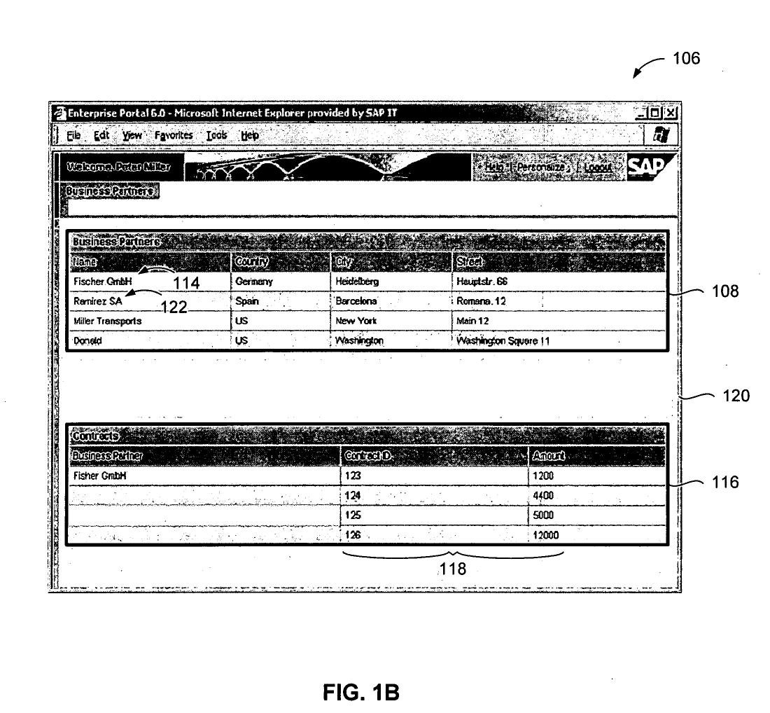

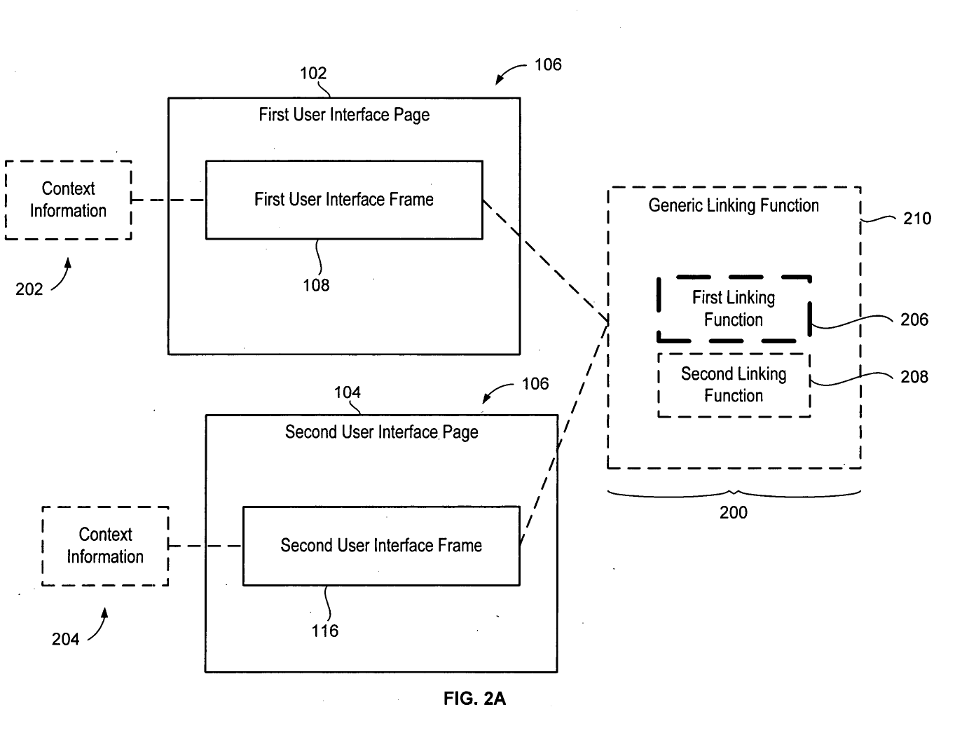

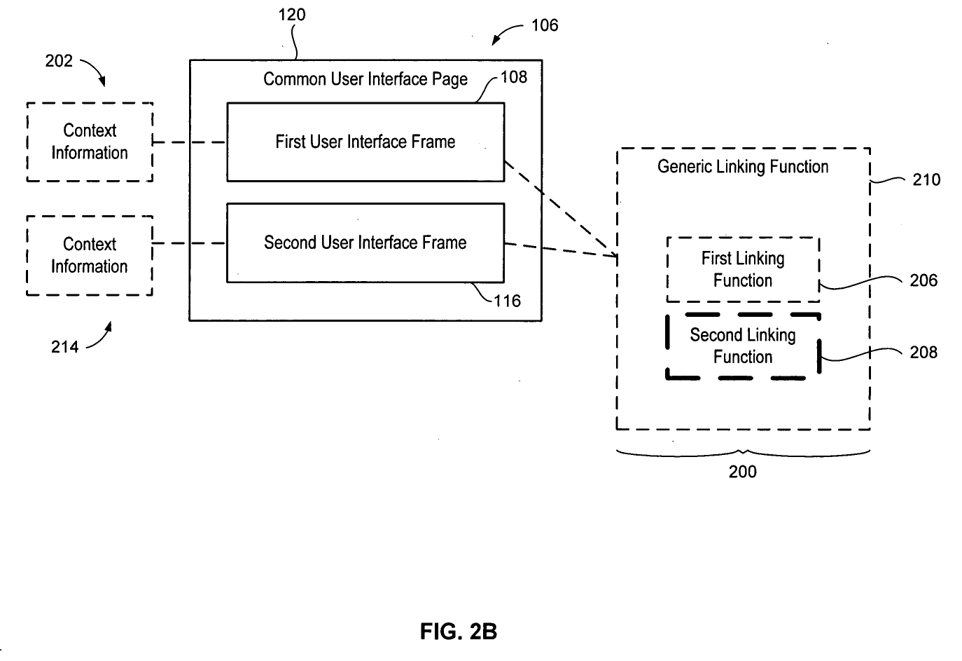

FIG. 1A shows an exemplary pair 100 of user interface pages 102 and 104 that can display two or more linked user interface frames, for example, user interface frames 108 and 116. The user interface pages 102 and 104 are displayed, at different times, in a graphical user interface (GUI) 106 of a computer device. For example, the computer device may be a desktop computer, and the GUI 106 may include a browser window on a display. As another example, the computer device may be a personal digital assistant (PDA), and the GUI 106 may include a touch-sensitive screen on the PDA. In any such embodiments, one user interface frame may be linked to another. The choice of a linking function depends on whether the user interface frames are displayed within separate user interface pages or within a common user interface page, as will be described with reference to FIG. 2A and FIG. 2B.

The first user interface page 102 may include one or more user interface frames, each of which may display various kinds of information. For example, an exemplary first user interface frame 108 displays address information 110 of various business partners 112. The GUI 106 may receive input associated with the first user interface frame 108. For example, a business partner named “Fischer GmbH” may be represented by a hyperlink 114 that the user can select with an input device. In a computer device such as a desktop computer, the user may select the hyperlink 114 with a mouse click or a keyboard stroke; in a computer device such as a PDA, the user may select the hyperlink 114 with the press of a stylus on a touch-sensitive screen.

Received input that is associated with the first user interface frame 108 may cause the second user interface page 104 to be loaded in the GUI 106. For example, the user may navigate to additional information associated with the business partner Fischer GmbH using the link 114. The second user interface page 104 may comprise one or more user interface frames. An exemplary second user interface frame 116 displays contract information 118 for the Fischer GmbH business partner 114. Here, the user interface frames 108 and 116 are displayed within separate user interface pages 102 and 104, and the navigation therefore takes place using a linking function for user interface frames on separate user interface pages. Another linking function may be used for linking user interface frames on a common user interface page, as will now be described.

FIG. 1B shows the first user interface frame 108 and the second user interface frame 116 displayed by the GUI 106 within an exemplary common user interface page 120. The GUI 106 may receive input associated with the first user interface frame 108 in the common user interface page 120 in the manner described above—for example by a mouse click, a keyboard stroke, or input from a touch-sensitive screen. However, instead of the user input causing the second user interface page 104 to be loaded, the input causes information in the second user interface frame 116 to be updated. For example, if the user selects the hyperlink 114 in the common user interface page 120, the information to which the link leads is displayed in the second user interface frame 116. If the user selects another hyperlink, for example “Ramirez SA” 122, information to which that link leads is displayed in the second user interface frame 116. For example, the second user interface frame 116 may be updated with contract information (not shown) for Ramirez SA if the user selects the hyperlink 122.

In the common user interface page 120, information displayed in the second user interface frame 116 may be updated while information displayed outside the second user interface frame 116 is substantially maintained. That is, in the common user interface page 120, the second user interface frame 116 may be updated without the entire common user interface page 120 being reloaded. In this case, the navigation to the second user interface frame 116 may take place using a linking function for user interface frames on a common user interface page.

Linking user interface frames as described with reference to FIG. 1A and FIG. 1B may be done using different segments of programming code, as will be described with reference to FIG. 2A and FIG. 2B. FIG. 2A shows context information 202 and 204 and programming code 200, part of which is used to link the first user interface frame 108 with the second user interface frame 116. Specifically, a first linking function 206 may be used to link the first user interface frame 108 with the second user interface frame 116 when the user interface frames 108 and 116 are on the separate user interface pages 102 and 104. In contrast, as is graphically depicted by the bold dashed lines in FIG. 2B, a second linking function 208 may be used to link the first user interface frame 108 with the second user interface frame 116 when the user interface frames 108 and 116 are on the common user interface page 120.

A generic linking function may permit flexibility by automatically selecting the appropriate segment of programming code 200 to be executed. For example, it could selectively execute the first linking function 206 or the second linking function 208. One advantage of this is that there is no need to change the programming code 200 when user interface frames on separate user interface pages are moved to a common user interface page.

As shown in FIG. 2A and FIG. 2B, an exemplary generic linking function 210 may comprise the first linking function 206 and the second linking function 208. The generic linking function 210 causes the first linking function 206 to be executed, at runtime, if the first user interface frame 108 and the second user interface frame 116 are to be displayed in separate user interface pages 102 and 104. If the first user interface frame 108 and the second user interface frame 116 are to be displayed in a common user interface page 120, the generic linking function 210 causes the second linking function 208 to be executed, at runtime.

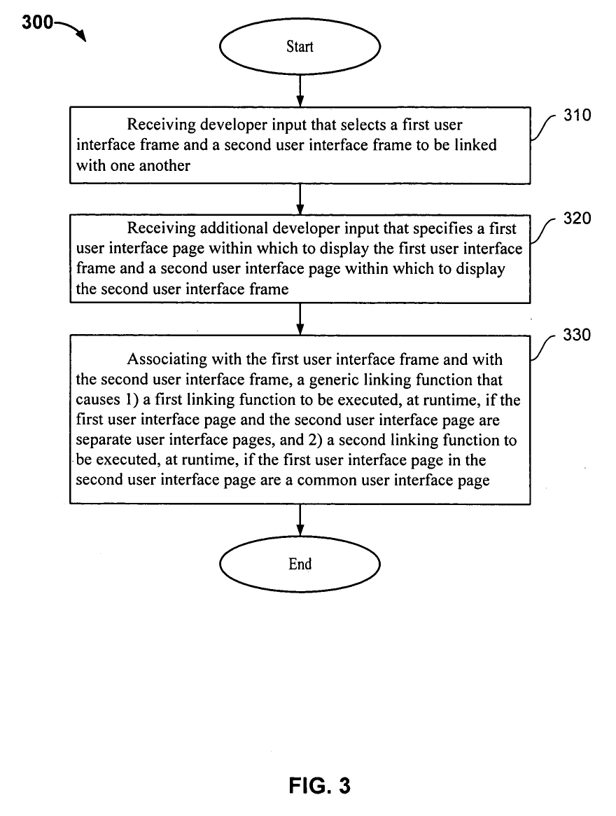

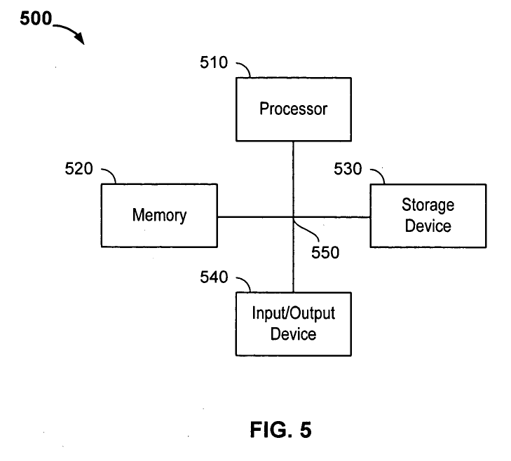

FIG. 3 is a flowchart of a method 300 of generically linking a first user interface frame with a second user interface frame. The method 300 may be performed by the execution of programming code on a computer device, for example an exemplary computer device 500 that is described in further detail with reference to FIG. 5. The actions enumerated below are included in the method 300.

The method 300 includes receiving, in an action 310, developer input that selects a first user interface frame and a second user interface frame to be linked with one another. For example, a computer device in a development environment (not shown) may receive, from a developer, input that selects the first user interface frame 108 and the second user interface frame 116 to be linked with one another. The first user interface frame 108 and the second user interface frame 116 may have been selected from a plurality of user interface frames (now shown) that may be displayed in a interface page environment, such as, for example, a company's portal environment.

The method also includes receiving, in an action 320, additional developer input that specifies a first user interface page within which to display the first user interface frame and a second user interface page within which to display the second user interface frame. For example, the computer device may receive, from the developer, input that specifies that the first user interface frame 108 is to be displayed within the first user interface page 102 and that further specifies that the second user interface frame 116 is to be displayed within the second user interface page 104. The computer device may store information linking the specific user interface frames 108 and 116 with the specific user interface pages 102 and 104 as context information 202 and 204. As another example, the computer device may receive, from the developer, input that specifies that the first user interface frame 108 and the second user interface frame 116 are to be displayed within the common user interface page 120. The computer device may store information linking the specific user interface frames 108 and 116 with the common user interface page 120 as context information 202 and 214.

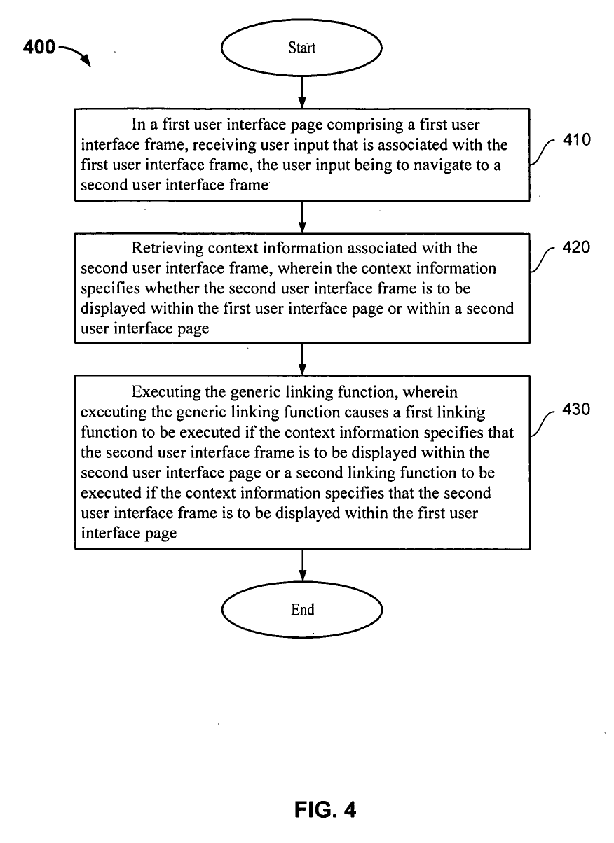

The method 300 further includes associating with the first user interface frame and the second user interface frame, in an action 330, a generic linking function that causes 1) a first linking function to be executed, at runtime, if the first user interface page and the second user interface page are separate user interface pages, and 2) a second linking function to be executed, at runtime, if the first user interface page and the second user interface page are a common user interface page. For example, the computer device, based on the additional developer input, may associate the generic linking function 210 with the first user interface frame 108 and with the second user interface frame 116. At runtime, the generic linking function 210 causes the computer device to execute either the first linking function 206 or to execute the second linking function 208, depending on whether the user interface frames are to be displayed within separate user interface pages or within a common user interface page. Runtime execution of the generic linking function is described in greater detail with reference to FIG. 4.

FIG. 4 is a flowchart of a method 400 of navigating from a first user interface frame to a second user interface frame. The method 400 may be performed by the programming code 200 when executed on a computer device, for example the exemplary computer device 500 that is described in further detail with reference to FIG. 5. The actions enumerated below are included in the method 400.

In a first user interface page comprising a first user interface frame, the method 400 includes receiving, in an action 410, user input that is associated with the first user interface frame, the user input being to navigate to a second user interface frame. For example, the computer device may display in its graphical user interface 106 the first user interface frame 108, within the first user interface page 102 or within the common user interface page 120. Further, the computer device may receive input associated with the first interface frame 108. Specifically, the computer device may receive input that a user has selected the hyperlink 114. Because the generic linking function 210 links the first user interface frame 108 with the second user interface frame 116, the computer system will interpret the selection of the hyperlink 114 as input to navigate to the second user interface frame 116, or to update the second user interface frame 116, depending on within which user interface page 104 or 120 the second user interface frame 116 is to be displayed.

The method also includes, in an action 420, retrieving context information associated with the second user interface frame, wherein the context information specifies whether the second user interface frame is to be displayed within the first user interface page or within a second user interface page. For example, based on the input received in the action 410, the computer device will retrieve the context information 204 or the context information 214. The context information 204 or 214 specifies whether the second user interface frame 116 is to be displayed within the second user interface page 104 or within the common user interface page 120, respectively.

The method 400 further includes, in an action 430, executing the generic linking function, wherein executing the generic linking function causes the first linking function to be executed if the context information specifies that the second user interface frame is to be displayed within the second user interface page or the second linking function to be executed if the context information specifies that the second user interface frame is to be displayed within the first user interface page. For example, referring to FIG. 2A, the generic linking function 210 will cause the first linking function 206 to be executed, since the context information 204 indicates that the second user interface frame is to be displayed within the second user interface page 104. Execution of the first linking function 206 will cause the second user interface page 104 to be loaded in the GUI 106. As another example, referring to FIG. 2B, the generic linking function 210 will cause the second linking function 208 to be executed, since the context information 214 indicates that the second user interface frame 116 is to be displayed within the common user interface page 120. Execution of the second linking function 208 will cause the second user interface frame 116 to be updated, while information displayed outside the second user interface frame 116 is substantially maintained.

FIG. 5 is a block diagram of a computer device 500 that can be used in the operations described above, according to one embodiment. The computer device 500 includes a processor 510, a memory 520, a storage device 530 and an input/output device 540. Each of the components 510, 520, 530 and 540 are interconnected using a system bus 550.

The processor 510 is capable of processing instructions for execution within the computer device 500. In one embodiment, the processor 510 is a single-threaded processor. In another embodiment, the processor 510 is a multi-threaded processor. The processor 510 is capable of processing instructions stored in the memory 520 or on the storage device 530 to display graphical information for a user interface on the input/output device 540.

The memory 520 stores information within the computer device 500. In one embodiment, the memory 520 is a computer-readable medium. In one embodiment, the memory 520 is a volatile memory unit. In another embodiment, the memory 520 is a non-volatile memory unit.

The storage device 530 is capable of providing mass storage for the computer device 500. In one embodiment, the storage device 530 is a computer-readable medium. In various different embodiments, the storage device 530 may be a floppy disk device, a hard disk device, an optical disk device, or a tape device.

The input/output device 540 provides input/output operations for the computer device 500. In one embodiment, the input/output device 540 includes a keyboard and/or pointing device. In one embodiment, the input/output device 540 includes a display unit for displaying GUIs as discussed above with reference to FIG. 1A, FIG. 1B, FIG. 2A and FIG. 2B.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations have been described. Nevertheless, it will be understood that various modifications may be made without departing from the spirit and scope of the invention. Accordingly, other embodiments are within the scope of the following claims.

What is claimed is:

1. In a computer device
1) that displays information in, and receives user input associated with, a plurality of user interface frames that are disposed within two or more user interface pages, and
2) that implements a first linking function to link user interface frames that are to be linked and displayed within separate user interface pages and a second linking function to link user interface frames that are to be linked and displayed within a common user interface page,
a method of generically linking a first user interface frame with a second user interface frame, the method comprising:
receiving developer input that selects the first user interface frame and the second user interface frame to be linked with one another;
receiving additional developer input that specifies a first user interface page within which to display the first user interface frame and a second user interface page within which to display the second user interface frame; and
associating, with the first user interface frame and with the second user interface frame, a generic linking function that causes
1) the first linking function to be executed, at runtime, if the first user interface page and the second user interface page are separate user interface pages, and
2) the second linking function to be executed, at runtime, if the first user interface page and the second user interface page are a common user interface page.

2. The method of claim 1, wherein the first user interface page and the second user interface page are portal pages that are displayed, one portal page at a time, in a browser window, wherein the browser window is displayed in a graphical user interface.

3. The method of claim 1, wherein the first user interface page and the second user interface page are screens that are displayed, one screen at a time, by a personal digital assistant device.

4. The method of claim 1, wherein the first user interface page and the second user interface page are separate user interface pages, the method further comprising receiving input associated with the first user interface frame, and based on the received input, executing the first linking function, causing the second user interface page to be loaded, wherein the second user interface page comprises the second user interface frame.

5. The method of claim 1, wherein the first user interface page and the second user interface page are a common user interface page, the method further comprising receiving input associated with the first user interface frame, and based on the received input, executing the second linking function, causing information displayed in the second interface frame to be updated while information displayed outside the second user interface frame is substantially maintained.

6. The method of claim 1, wherein the additional developer input is stored as context information that is associated with at least one of:
a) the first user interface frame, and
b) the second user interface frame.

7. The method of claim 6, wherein the generic linking function comprises the first linking function and the second linking function, and wherein the generic linking function causes either the first linking function or the second linking function to be executed based on the context information.

8. The method of claim 1, wherein the first user interface page and the second user interface page are initially separate user interface pages, and wherein the first user interface page comprises the first user interface frame and the second user interface page comprises the second user interface frame, the method further comprising receiving user input that specifies that the second interface frame is to be subsequently displayed within the first user interface page.

9. In a computer device
1) that displays information in, and receives user input associated with, a plurality of user interface frames that are disposed within two or more user interface pages, and
2) that implements a first linking function to link user interface frames that are to be linked and displayed within separate user interface pages and a second linking function to link user interface frames that are to be linked and displayed within a common user interface page,
a computer program product tangibly embodied in an information carrier, the computer program product comprising instructions that, when executed, cause a processor to perform operations comprising:
receiving developer input that selects a first user interface frame and a second interface frame to be generically linked with one another;
receiving additional developer input that specifies a first user interface page within which to display the first user interface frame and a second user interface page within which to display the second user interface frame; and
associating, with the first user interface frame and with the second user interface frame, a generic linking function that causes
1) the first linking function to be executed, at runtime, if the first user interface page and the second user interface page are separate user interface pages, and
2) the second linking function to be executed, at runtime, if the first user interface page and the second user interface page are a common user interface pages.

10. In a computer device
1) that displays information in, and receives user input associated with, a plurality of user interface frames that are disposed within two or more user interface pages,
2) that implements a first linking function to link user interface frames that are to be linked and displayed within separate user interface pages and a second linking function to link user interface frames that are to be linked and displayed within a common user interface page, and
3) that associates a generic linking function to a first user interface frame and a second user interface frame, wherein the generic linking function comprises the first linking function and the second linking function,
a method of navigating from the first user interface frame to the second user interface frame, the method comprising:
in a first user interface page comprising the first user interface frame, receiving user input that is associated with the first user interface frame, the user input being to navigate to the second user interface frame;
retrieving context information associated with the second user interface frame, wherein the context information specifies whether the second user interface frame is to be displayed within the first user interface page or within a second user interface page; and
executing the generic linking function, wherein executing the generic linking function causes the first linking function to be executed if the context information specifies that the second user interface frame is to be displayed within the second user interface page or the second linking function to be executed if the context information specifies that the second user interface frame is to be displayed within the first user interface page.

11. The method of claim 10, wherein the first user interface page and the second user interface page are portal pages that are displayed, one portal page at a time, in a browser window, wherein the browser window is displayed in a graphical user interface.

12. The method of claim 10, wherein the first user interface page and the second user interface page are screens that are displayed, one screen at a time, by a personal digital assistant device.

13. The method of claim 10, wherein the first user interface page and the second user interface page are separate user interface pages, the method further comprising receiving input associated with the first user interface frame, and based on the received input, executing the first linking function, causing the second user interface page to be loaded, wherein the second user interface page comprises the second user interface frame.

14. The method of claim 10, wherein the first user interface page and the second user interface page are a common user interface page, the method further comprising receiving input associated with the first user interface frame, and based on the received input, executing the second linking function, causing information displayed in the second interface frame to be updated while information displayed outside the second user interface frame is substantially maintained.

15. In a computer device
1) that displays information in, and receives user input associated with, a plurality of user interface frames that are disposed within two or more user interface pages,
2) that implements a first linking function to link user interface frames that are to be linked and displayed within separate user interface pages and a second linking function to link user interface frames that are to be linked and displayed within a common user interface page, and
3) that associates a generic linking function to a first user interface frame that is linked to a second user interface frame, wherein the generic linking function comprises the first linking function and the second linking function,
a computer program product tangibly embodied in an information carrier, the computer program product comprising instructions that, when executed, cause a processor to perform operations comprising:
in a first user interface page comprising a first user interface frame, receiving user input that is associated with the first user interface frame, the user input being to navigate to a second user interface frame;
retrieving context information associated with the second user interface frame, wherein the context information specifies whether the second user interface frame is to be displayed within the first user interface page or within a second user interface page; and
executing the generic linking function, wherein executing the generic linking function causes the first linking function to be executed if the context information specifies that the second user interface frame is to be displayed within the second user interface page or the second linking function to be executed if the context information specifies that the second user interface frame is to be displayed within the first user interface page.
